(19) United States
(12) Patent Application Publication
(10) Pub. No.: US 2013/0175478 A1
(43) Pub. Date: Jul. 11, 2013

(54) Reactive, non-corrosive, and dermal-friendly composition and methods for manufacturing

(71) Applicants: Burt R. Sookram, Palm Harbor, FL (US); John W. Veenstra, Plano, TX (US)

(72) Inventors: Burt R. Sookram, Palm Harbor, FL (US); John W. Veenstra, Plano, TX (US)

(73) Assignee: NOBLE ION LLC, Frisco, TX (US)

(21) Appl. No.: 13/346,160

(22) Filed: Jan. 9, 2012

(51) Int. Cl. H01B 1/06

(52) U.S. Cl. 252/500; 204/164

(57) ABSTRACT

This invention relates to a process for modifying a strong acid/salt solution or strong base/salt solution, and to the resulting modified solution. The modifications of this invention stably increase the reactivity of the solution while maintaining the non-corrosive and dermal-friendly characteristics of the solution. In particular, the inventive composition does not injure or irritate skin, as might an unmodified strong acid or strong base, but retains sufficient strong acid or strong base qualities that it tends to weaken intermolecular bonds and break covalent bonds. By way of example, combining the inventive composition with a biocide agent may result in an effective anti-microbial, anti-bacterial, or anti-viral solution that is non-corrosive and dermal friendly.

### FIELD OF THE INVENTION

This invention is directed at strong-acid/salt and strong-base/salt compositions that have been modified through use of a charging process to be highly-reactive yet stable, non-corrosive, and dermal-friendly.

### BACKGROUND OF THE INVENTION

Hydrochloric acid (HCl), a polar molecule, dissolves in water (H₂O), another polar molecule, by shifting a positive hydrogen nucleus (proton) away from the acid to the water, leaving a hydronium cation (H₃O⁺) and a chlorine anion (Cl⁻). This is commonly represented by the equation “H₂O+HCl→H₃O⁺+Cl⁻” where the “→” indicates that the dissociation of the acid is almost entirely one-way, a characteristic of a “strong acid.” Similarly, sodium hydroxide (NaOH), a base, dissolves in water to form a sodium cation (Nat) and a hydroxide anion (OH⁻). This is commonly represented by the equation “NaOH→Na⁺ (aq)+OH⁻ (aq)” (or alternatively, “NaOH+(H₂o)ₙ →[Na(H₂o)ₙ]⁺+OH⁻”), where the “→” indicates that the dissociation of the base is almost entirely one-way, a characteristic of “strong base.”

As a practical matter, any given atom or molecule is “reactive” with another if, under the right set of circumstances, it will interact with the other molecule by breaking existing bonds and/or forming new bonds. Because strong acids and bases dissociate in water to their ionic components almost completely in water, they are highly reactive with other molecules. For example, because of their polar nature, H₃O⁺ and OH⁻ may affect weaker intermolecular bonds, they may break some covalent bonds, and they may form new bonds and new molecules. When a dissociated strong acid or base is brought into contact with a cell membrane, composed of complex proteins and lipids, the highly polarized H₃O⁺ or OH⁻ may weaken some bonds and break other bonds; because the proteins and lipids contribute to the structural integrity of the membrane, the H₃O⁺ or OH⁻ effectively creates a hole, of sorts, in the cell membrane. Thus the cell, which might otherwise be protected by its cell membrane, becomes susceptible to the delivery of other materials, such as anti-microbial or anti-bacterial biocides, into the interior of the cell.

Strong acids and bases, however, have other properties which make them unsuitable for use in medical or cosmeceutical applications. For example, with hydrochloric acid, the dissociated chlorine anion reacts with metal, corroding and weakening the metal and releasing hydrogen gas. This property makes storage of hydrochloric acid in metal containers both problematic and potentially dangerous. Further, although the outermost layer of the epidermis (skin) includes a layer of dead cells that protect the living cells beneath, if the hydrochloric acid is sufficiently concentrated, it can destroy that layer of dead skin cells, exposing the more vulnerable dermal cells beneath. This property renders concentrated hydrochloric acid generally unsuitable for use in applications where it will come into contact with skin. Likewise, a strong base, such as sodium hydroxide, may etch glass containers and can destroy and/or burn skin cells, and thus, like hydrochloric acid, is problematic to use and store.

The reactive nature of a strong acid or base can be controlled by diluting it in sufficient water; however, the volume of the diluted acid or base needed to provide sufficient H₃O⁺ or OH⁻ makes this tactic impractical. Alternatively, the strong acid or base may be combined with an appropriate salt. For example, if water, hydrochloric acid, and ammonium chloride are combined in solution, the intermolecular interactions between the H₃O⁺, NH₄⁺, and Cl⁻ are sufficient to keep the solution from corroding metals and from irritating or destroying skin. Likewise, if water, sodium hydroxide, and ammonium hydroxide are combined in solution, the intermolecular interactions between the Na⁺, NH₄⁺, NH₂⁻, and OH⁻ are sufficient to keep the solution from irritating or destroying skin. However, these same intermolecular interactions leave the solution insufficiently reactive to affect the bonds in the proteins and lipids of cell membranes.

What is needed, therefore, is a composition that is reactive like a strong acid or strong base, yet can be safely stored and used, for example, in medical and cosmeceutical applications.

### SUMMARY OF THE INVENTION

Our invention uses a pulsed direct current to energize a solution of a concentrated strong acid or base, a salt, and water, such that the resulting composition does not have the expected corrosive or caustic properties, it does not have the expected skin-damaging properties, yet it is sufficiently reactive that it has the ability to disrupt the structural integrity of cell membranes. Our application is directed at the resulting composition itself as well as the process for making that composition.

### BRIEF DESCRIPTION OF THE DRAWINGS

FIG. 1 is a flowchart of a preferred embodiment of the inventive process using a strong acid.

FIG. 2 is a flowchart of an alternative embodiment of the inventive process using a strong acid.

FIG. 3 is a block diagram of equipment used in performing an embodiment of the inventive process.

FIG. 4 is a block diagram of an alternative set of equipment used in performing an embodiment the inventive process.

FIG. 5 is a flowchart of a preferred embodiment of the inventive process using a strong base.

FIG. 6 is a flowchart of an alternative embodiment of the inventive process using a strong base.

### DETAILED DESCRIPTION OF THE INVENTION

### Strong Acid Embodiments

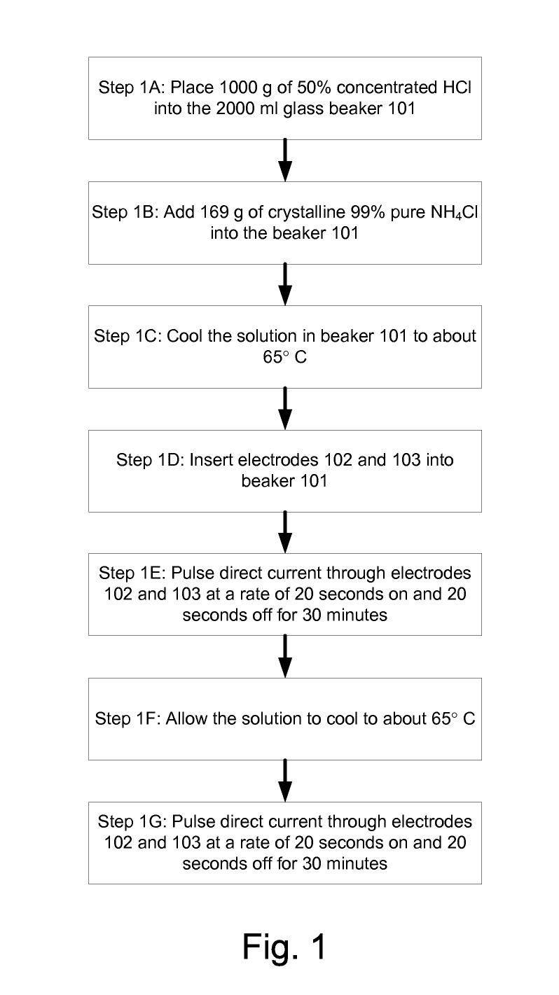

FIG. 1 shows a flowchart of a preferred embodiment of the inventive process using a strong acid, namely hydrochloric acid. In step 1A, we placed about 1000 grams of the 50% concentrated hydrochloric acid into a 2000 ml glass beaker 101. In step 1B, we added about 169 grams of crystalline 99% pure ammonium chloride to beaker 101. Addition of the ammonium chloride generated heat, and so we carefully monitored the rate at which we added the ammonium chloride and stirred the mixture regularly. In step 1C, once all of the ammonium chloride was dissolved in the acid, we allowed the solution to cool to about 65° C. At this point, the solution contained a mix of hydronium and ammonium cations, and hydroxide and chlorine anions; the measured conductivity was less than 100 mV, the measured proton count was about 1.0×10²³ per μb, and the pH was about 1.3 to 1.4. (Note that where we disclose and/or claim numeric values or ranges of values of conductivity, proton count, or pH of the solution, we refer to conductivity measurements made on the pure solution, proton count measurements made on a 1 gram sample of the solution, and pH measurements made on a 0.1% concentration of the solution.)

Based on our observations, we believe that at this stage of the process, the attractions between the oppositely charged ions in the solution made it less corrosive and more dermal-friendly than hydrochloric acid. However, the solution lacked those qualities that would make it sufficiently reactive to disrupt covalent and intermolecular bonds.

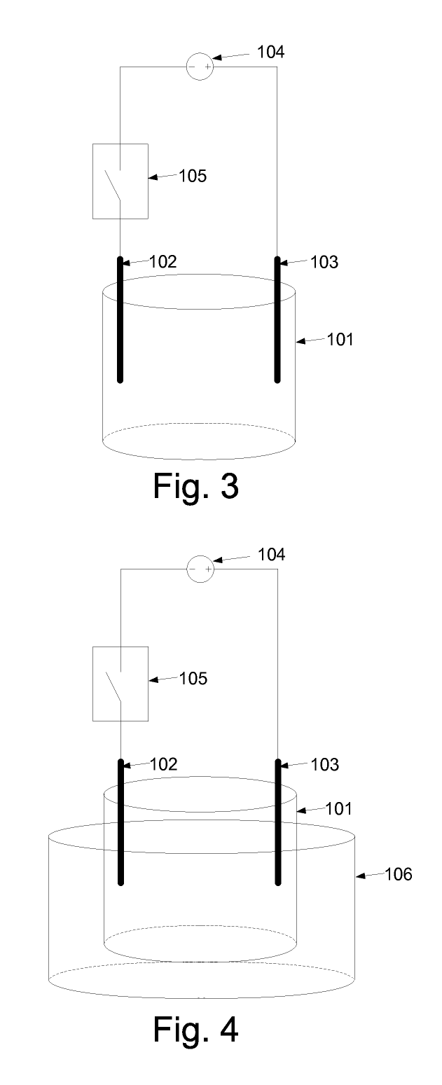

In step 1D, we placed two electrodes 102 and 103 into the beaker 101 at opposite sides of the beaker, away from the walls of the beaker, and partially submerged in the solution. We connected the electrodes 102 and 103 to a direct current power source 104 with an inline switch 105. Switch 105 could be a manual switch, but in practice, we found that we could use a strobe light controller, laboratory voltage pulser, or comparable circuit to provide the direct current pulses. FIG. 3 shows a block diagram of the equipment used in an embodiment of the inventive process.

In step 1E, we pulsed a 3 amp direct current at 10 volts through the solution between the electrodes for about 30 minutes, where the pulsing period was about 20 seconds on and 20 seconds off. After allowing the solution to cool in Step 1F, we found the measured conductivity was about 495 mV, the measured proton count was about 0.95×10²⁵ per μb, and the pH was about 1.21.

In Step 1G, after the first period of pulsing the current through the solution, and after the solution had cooled, we performed a second round of pulsing, comparable to the first and lasting a length of about 30 minutes. After this second round of pulsing, the measured conductivity was about 1120 mV, the measured proton count was about 0.95×10²⁵ per μb, and the pH was about 1.20. Over time (several months) the conductivity did not measurably decrease, suggesting that the second round of pulsing not only increased the reactivity but added stability to the composition.

While not binding ourselves to specific theories, based on our empirical observations, we believe that the controlled application of direct current increases the lengths of the bonds in the polar molecules, leading to higher reactivity. Further, because the current is pulsed, it does not interfere with the intermolecular bonds between the oppositely-charged ions (and in fact strengthens those bonds), thus retaining and enhancing the composition's non-corrosive and dermal-friendly qualities. Further, because of the stability of the intermolecular bonds, when the composition is stored under non-adverse conditions (for example, away from extreme heat, light, pressure, or electromagnetic radiation), it retains its reactive, non-corrosive, and dermal-friendly qualities indefinitely. Further, consistent with our observations, we found that when we used steady (non-pulsed) or alternating current, or higher-power current, or when we failed to control the temperature during the pulsing process, the composition did not have these enhanced reactive, non-corrosive, and dermal-friendly qualities. (This does not, however, preclude the use of other energy sources, such as sound, electricity, light, or mechanical sources, provided the application of energy does not break down the intermolecular bonding.) Thus, this embodiment addresses the need for a stable composition that is reactive, like a strong acid, yet does not corrode metal or irritate skin.

In other embodiments, the concentration of the acid may be varied without affecting the general process or the characteristics of the resulting composition; however, use of too weak of a concentration may lower the ranges of conductivity and proton count in the final composition and therefore limit its usefulness. The efficacy of a given concentration of acid can be determined from routine experimentation based on the embodiments disclosed in this patent

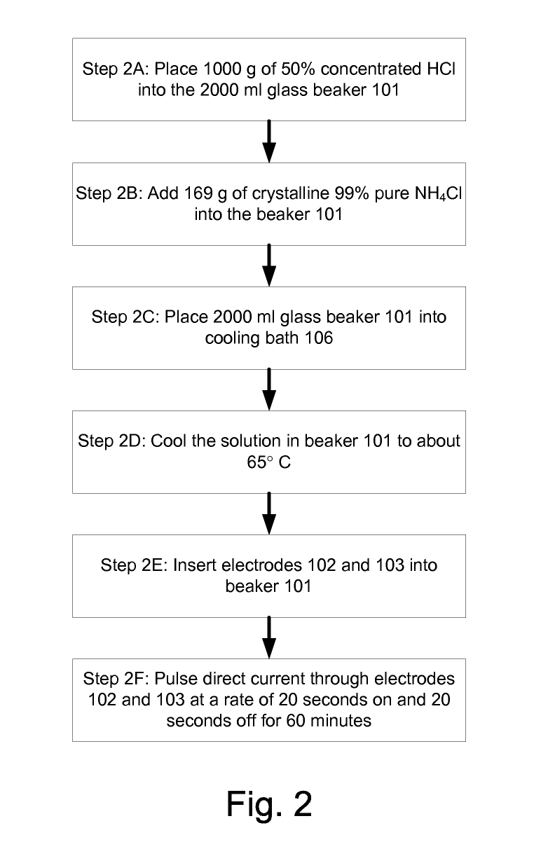

In the embodiment described above, pulsing of the solution occurred in two steps. This was to help control the temperature of the solution, as we found that excessive heat appeared to break down intermolecular bonds instead of simply energizing them, leading to a solution that did not have the desired properties. In other embodiments, the pulsing can occur in a single step, provided that the temperature of the solution is kept under about 90° C. using cooling techniques that are known in the art, for example, partially submersing the mixing vessel in a cooling bath, as shown in the block diagram of FIG. 4. The process described in the flowchart of FIG. 2 differs from the process of FIG. 1 in that after the HCl and NH₄Cl are mixed together, the beaker 101 is placed into a cooling bath 106, which maintains the temperature during charging, and the pulsing process is performed in a single 60-minute step.

In other embodiments, the voltage, amperage, period, and duration of the pulsing current could be varied without adversely affecting the desired properties. Such variations could be necessitated, for example, by the size of the electrodes, the size of the beaker, and the volume of the acid/salt solution. In practice, we found that we could obtain the desired properties of the modified acid/salt solution with voltages ranging from 4 to 16 volts, currents ranging from 1 to 20 amps, pulse periods ranging from 5 to 60 seconds on and 5 to 60 seconds off, and pulsing current duration ranging from 20 to 70 minutes. In determining these ranges, we applied the pulsing current at 1 atmosphere; varying the pressure could broaden or narrow these ranges without effecting the end results, and new effective ranges for different pressure constraints could be determined through routine experimentation.

In the preferred embodiment, we used quantities of the various components commensurate with what was practical in a laboratory setting; obviously, in an industrial production setting, the quantities of the various components used would be a function of the manufacturing equipment and desired amount of final product. Designing the optimal manufacturing environment can be derived from the embodiments disclosed in this patent using routine chemical engineering techniques.

In other embodiments, the ammonium chloride salt can be replaced with other chloride salts such as, for example, sodium chloride, potassium chloride, calcium chloride, magnesium chloride, aluminum chloride, zinc chloride, nickel chloride, lead chloride, copper chloride, ferrous chloride, ferric chloride, gold chloride, or comparable chloride salts (or combinations of chloride salts). Alternatively, the inventive composition can use a chlorite salt, for example, sodium chlorite, potassium chlorite, calcium chlorite, ammonium chlorite, magnesium chlorite, aluminum chlorite, or comparable chlorite salts (or combinations of such chlorite salts). The choice of one particular salt over another does not affect the general process or characteristics of the resulting composition; however, the choice of a particular salt and its purity may change the proportions of the various components used in the process, it may change the measured ranges of conductivity and proton count of the composition, and selection of a particular salt may result in the composition having useful or detrimental characteristics beyond those described here. The optimal quantities of components and length/magnitude of current pulsing for any given substitute salt can be determined from routine experimentation based on the embodiments disclosed in this patent.

In other embodiments, the hydrochloric acid can be replaced with another strong acid. By way of example, the following strong acids could be used: hydroiodic acid (HI), hydrobromic acid (HBr), perchloric acid, sulfuric acid (H₂SO₄), nitric acid (HNO₃), and chloric acid (HClO₃). The choice of one particular acid over another does not affect the general process or characteristics of the resulting composition; however, the choice of a particular acid and its purity may change the proportions of the various components used in the process, it may change the measured ranges of conductivity and proton count of the composition, and selection of a particular acid may result in the composition having useful or detrimental characteristics beyond those described here. The optimal quantities of components and length/magnitude of current pulsing for any given substitute acid can be determined from routine experimentation based on the embodiments disclosed in this patent.

In selecting substitute acid and/or salt components, we have found the following guidelines to be true. First, we found that ammonium salts were preferable over non-ammonium salts. While not binding ourselves to specific theories, we believe that because of its size and polarity, the NH₄⁺ tends to form relatively stable intermolecular bonds with negatively-charged anions (for example, Cl⁻), even after the direct current pulsing step. Thus the composition remains non-corrosive and dermal-friendly after charging, but the increased polarity makes the composition sufficiently reactive to disrupt other intermolecular or intramolecular bonds, such as those found in cell membranes. This preference for an ammonium salt notwithstanding, non-ammonium salts which dissociate into cations that behave similarly to NH₄⁺ may prove suitable, especially in applications where a non-ammonium salt brings additional benefits.

Second, we found selecting a salt with the same or similar anion to the acid (for example, Cl⁻) was preferable over those with dissimilar anions. We believe that with a more homogenous the solution, there will be fewer undesirable side reactions. However, selecting an acid and salt with dissimilar anions may nonetheless prove suitable, especially in applications where the dissimilar anion of the salt brings additional benefits.

Thus, using these guidelines, by way of example and not limitation, the following acid and salt pairs could be used: hydroiodic acid (HI) and ammonium iodide (NH₄I), hydrobromic acid (HBr) and ammonium bromide (NH₄Br), perchloric acid and ammonium perchlorate (NH₄ClO₄), sulfuric acid (H₂SO₄) and ammonium sulfate (NH₄SO₄), nitric acid (HNO₃) and ammonium nitrate (NH₄NO₃), and chloric acid (HClO₃) and ammonium chlorate (NH₄ClO₃). We note, however, that because some of these acid/salt combinations can be highly reactive (ammonium nitrate, for example, is used as an oxidizing agent in explosives, and ammonium perchlorate is used as a solid rocket propellant), the steps required to maintain safe production may make those combinations economically impractical.

Finally, while we specifically note the use of the modified acid/salt composition in the context of making cell membranes more susceptible to biocide agents, our inventive composition is not limited to such anti-microbial, anti-bacterial, or anti-viral uses. Indeed, we believe that our inventive composition may prove useful in any application where a reactive acid-based composition is needed, but where the composition must be non-corrosive and dermal-friendly. For example, we believe that the composition would be useful in hydraulic fracturing, applications requiring the use of an electrolyte, removal of carbonates and silicates, PCB removal and cleanup, and soil remediation following the over-use of urea.

### Strong Base Embodiment

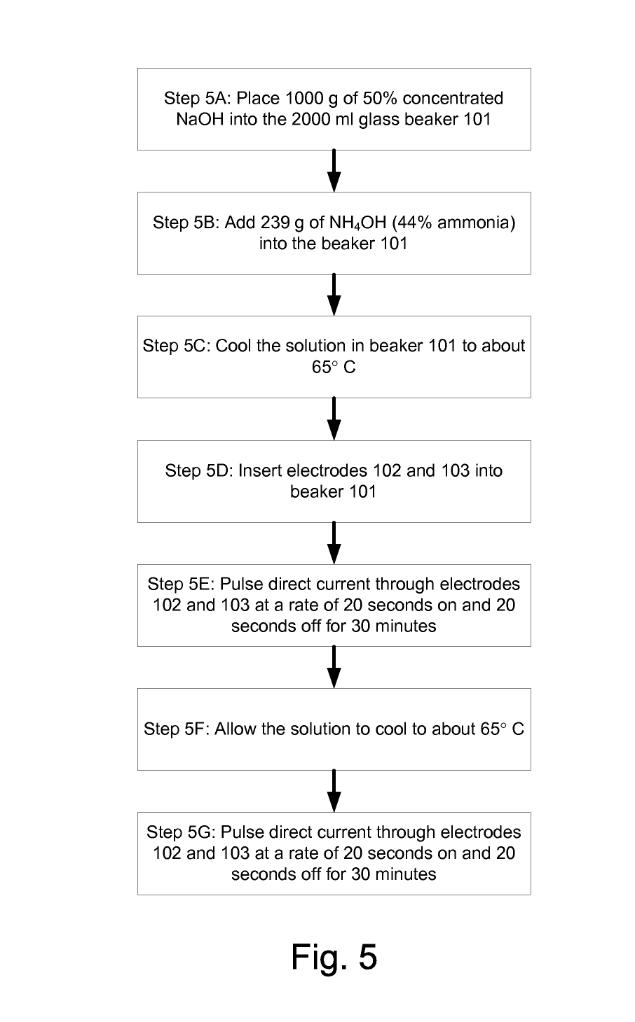

FIG. 5 shows a flowchart of a preferred embodiment of the inventive process using a strong base, namely sodium hydroxide (NaOH). In step 5A. we placed about 1000 grams of a 50% pure sodium hydroxide in the form of solid beads into a 2000 ml glass beaker 101. In step 5B, we added about 239 grams of ammonium hydroxide with a maximum of 44% ammonia. Addition of the ammonium hydroxide generated heat, and so we carefully monitored the rate at which we added the ammonium hydroxide and stirred the mixture regularly. In step 5C, once all of the ammonium hydroxide was dissolved in the sodium hydroxide, we allowed the solution to cool to about 65° C. At this point, the solution contained a mix of Na⁺, NH₄⁺, NH₂⁻, and OH⁻, the measured conductivity of the solution was less than 100 mV, the measured proton count was about 3.1×10²⁴ per μb, and the pH was about 12.1 for a 0.1% solution.

Based on our observations, we believe that at this stage of the process, the attractions between the oppositely charged ions in the solution made it less caustic and more dermal-friendly than sodium hydroxide. However, the solution lacked those qualities that would make it sufficiently reactive to disrupt covalent and intermolecular bonds.

In step 5D, we placed two electrodes 102 and 103 into the beaker 101 at opposite sides of the beaker, away from the walls of the beaker, and partially submerged in the solution. We connected the electrodes 102 and 103 to a direct current power source 104 with an inline switch 105, allowing the current to turn on and off. Switch 105 could be a manual switch, but in practice, we found that we could use a strobe light controller, laboratory voltage pulser, or comparable circuit to provide the direct current pulses. FIG. 3 shows a block diagram of the equipment used in an embodiment of the inventive process.

In step 5E, we pulsed a 3 amp direct current at 10 volts through the solution between the electrodes for about 30 minutes, where the pulsing period was about 20 second on and 20 seconds off. After allowing the solution to cool in Step 5F, we found the measured conductivity was about 900 mV, the measured proton count was about 3.1×10²⁴ per μb, and the pH of a 1% solution was about 12.21.

In step 5G, after the first period of pulsing the current through the solution, and after the solution had cooled for about four hours, we performed a second round of pulsing, comparable to the first and lasting a length of about 30 minutes. After this second round of pulsing, the measured conductivity was about 2100 mV, the measured proton count was about 2.8×10²⁶ per μb, and the pH was about 12.20. Over time (several months) the conductivity did not measurably decrease, suggesting that the second round of pulsing not only increased the reactivity but added stability to the composition.

While not binding ourselves to specific theories, based on our empirical observations, we believe that the controlled application of direct current increases the lengths of the bonds in the polar molecules, leading to higher reactivity. Because the current is pulsed, it does not interfere with the intermolecular bonds between the oppositely-charged ions, thus retaining the composition's non-caustic and dermal-friendly qualities. Further, because of the stability of the intermolecular bonds, when the composition is stored under non-adverse conditions (for example, away from heat, light, pressure, or electromagnetic radiation), it retains its reactive, non-caustic, and dermal-friendly qualities indefinitely. Further, consistent with our observations, we found that when we used steady (non-pulsed) or alternating current, or higher-power current, or when we failed to control the temperature during the pulsing process, the composition did not have these enhanced reactive, non-caustic, and dermal-friendly qualities. (This does not, however, preclude the use of other energy sources, such as sound, electricity, light, or mechanical sources, provided the application of energy does not break down the intermolecular bonding.) Thus, this embodiment addresses the need for a stable composition that is reactive, like a strong base, yet does not corrode metal or irritate skin.

In other embodiments, the concentration of the base may be varied without affecting the general process or the characteristics of the resulting composition; however, use of too weak of a concentration may lower the ranges of conductivity and proton count in the final composition and therefore limit its usefulness. The efficacy of a given concentration of base can be determined from routine experimentation based on the embodiments disclosed in this patent

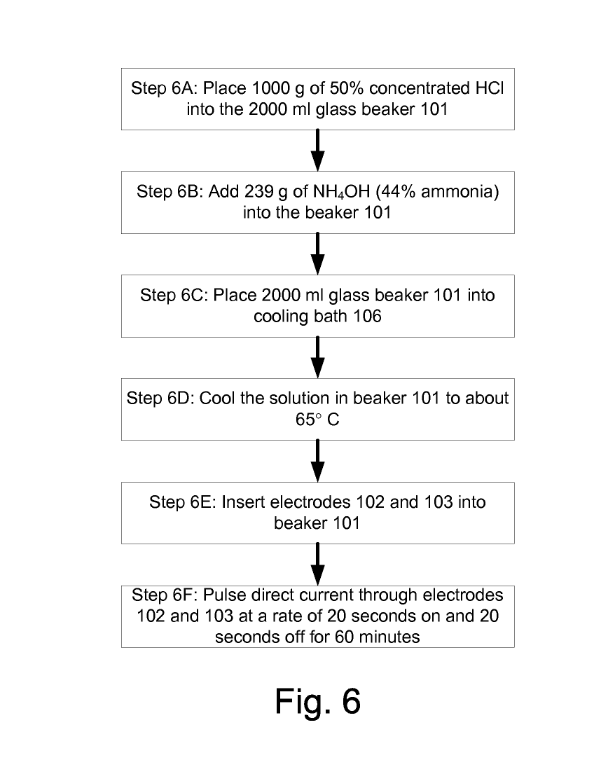

In the embodiment described above, pulsing of the solution occurred in two steps. This was to help control the temperature of the solution, as we found that temperatures above 120° C. appeared to break down intermolecular bonds instead of simply energizing them, leading to a solution that did not have the desired properties. In other embodiments, the pulsing can occur in a single step, provided that the temperature of the solution is kept under about 65° C. using cooling techniques that are known in the art, for example, partially submersing the mixing vessel in a cooling bath, as shown in the block diagram of FIG. 4. The process described in the flowchart of FIG. 6 differs from the process of FIG. 5 in that after the NaOH and NH₄OH are mixed together, the beaker 101 is placed into an cooling bath 106, which maintains the temperature during charging, and the pulsing process is performed in a single 60-minute step.

In other embodiments, the voltage, amperage, period, and duration of the pulsing current could be varied without adversely affecting the desired properties. Such variations could be necessitated, for example, by the size of the electrodes, the size of the beaker, and the volume of the base/salt solution. In practice, we found that we could obtain the desired properties of the modified base/salt solution with voltages ranging from 4 to 16 volts, currents ranging from 2 to 5 amps, pulse periods ranging from 5 to 60 seconds on and 5 to 60 seconds off, and pulsing current duration ranging from 20 to 60 minutes. In determining these ranges, we applied the pulsing current at 1 atmosphere; varying the pressure could broaden or narrow these ranges without effecting the end results, and new effective ranges for different pressure constraints could be determined through routine experimentation.

In the preferred embodiment, we used quantities of the various components commensurate with what was practical in a laboratory setting; obviously, in an industrial production setting, the quantities of the various components used would be a function of the manufacturing equipment and desired amount of final product. Designing the optimal manufacturing environment can be derived from the embodiments disclosed in this patent using routine chemical engineering techniques.

In other embodiments, the ammonium hydroxide salt can be replaced with other hydroxide salts such as, for example, potassium hydroxide (KOH), calcium hydroxide (Ca(OH)₂), magnesium hydroxide (Mg(OH)₂), aluminum hydroxide (Al(OH)₃), zinc hydroxide (Zn(OH)₂), silver hydroxide (AgOH), nickel hydroxide (Ni(OH)₂, lead hydroxide (Pb(OH)₂), copper hydroxide (CuOH), ferrous hydroxide (Fe(OH)₂), ferric hydroxide (Fe(OH)₃), or gold hydroxide (AuOH), or combinations of such hydroxide salts. Alternatively, the ammonium hydroxide salt can be replaced with other ammonium salts, including ammonium carbonate ((NH₄)₂CO₃), ammonium chloride (NH₄Cl), and ammonium nitrate (NH₄NO₃). The choice of one particular salt over another does not affect the general process or the characteristics of the resulting composition; however, the choice of a particular salt and its purity may change the proportions of the various components used in the process, it may change the measured ranges of conductivity and proton count of the composition, and a given salt may result in the composition having useful characteristics beyond those described here. The optimal quantities of components and length/magnitude of current pulsing for any given substitute salt can be determined from routine experimentation based on the embodiments disclosed in this patent.

In other embodiments, the sodium hydroxide can be replaced by another strong base. By way of example, the following strong bases could be used: lithium hydroxide (LiOH), potassium hydroxide (KOH), rubidium hydroxide (RbOH), cesium hydroxide (CsOH), calcium hydroxide (Ca(OH)₂), strontium hydroxide (Sr(OH)₂), barium hydroxide (Ba(OH)₂), and magnesium hydroxide (Mg(OH)₂). The choice of one particular base over another does not affect the general process or characteristics of the resulting composition; however, the choice of a particular base and its purity may change the proportions of the various components used in the process, it may change the measured ranges of conductivity and proton count of the composition, and selection of a given base may result in the composition having useful or detrimental characteristics beyond those described here. The optimal quantities of components and length/magnitude of current pulsing for any given substitute base can be determined from routine experimentation based on the embodiments disclosed in this patent.

In selecting substitute base and/or salt components, we have found the following guidelines to be true. First, we found that ammonium hydroxide salt was preferable over non-ammonium hydroxide salts. While not binding ourselves to specific theories, we believe that because of its size and polarity, in the presence of a strong base, the ammonium hydroxide will act like a weak acid, in that it will lose a proton, yielding an amide anion (NH₂⁻), which tends to form relatively stable intermolecular bonds with positively-charged cations (for example, Na⁺), even after the direct current pulsing step. Thus the composition remains non-caustic and dermal-friendly after charging, but the increased polarity makes the composition sufficiently reactive to disrupt other intermolecular or intramolecular bonds, such as those found in cell membranes. This preference for an ammonium salt notwithstanding, non-ammonium salts which dissociate into anions that behave similarly to NH₂⁻ may prove suitable, especially in applications where a non-ammonium salt brings additional benefits.

Second, we found selecting a salt with the same or similar anion to the base (for example, OH⁻) was preferable over those with dissimilar anions. We believe that with a more homogenous the solution, there will be fewer undesirable side reactions. However, selecting a base and salt with dissimilar anions may nonetheless prove suitable, especially in applications where the dissimilar anion of the salt brings additional benefits. Thus, using these guidelines, by way of example and not limitation, the preferred hydroxide salt for each of the strong bases listed above is ammonium hydroxide.

Finally, while we specifically note the use of the modified base/salt composition in the context of making cell membranes more susceptible to biocide agents, our inventive composition is not limited to such anti-microbial, anti-bacterial, or anti-viral uses. Indeed, we believe that our inventive composition may prove useful in any application where a reactive alkali-based composition is needed, but where the composition must be non-caustic and dermal-friendly. For example, we believe that the composition would be useful in preventing and treating mold and fungus, prevention of rust, and lowering the water activity on products such as dried pet foods, ready-to-eat meals, drying paper, and manufacture of soaps and detergents.

While specific embodiments have been illustrated and described, numerous modifications come to mind without significantly departing from the spirit of the invention, and the scope of protection is only limited by the scope of the accompanying claims.

1. A method for preparation of a modified hydrochloric acid/chloride salt solution, comprising:
pulsing a direct current through a solution of hydrochloric acid and a chloride salt;
where the pulsing is of sufficient duration, frequency, and magnitude that after the pulsing, the solution will have a stable higher level of conductivity and higher proton count than it had prior to the pulsing step.

2. The method of claim 1, where:
the direct current is between 1 and 20 amps and between 4 and 16 volts;
each pulse of direct current lasts between 5 and 60 seconds;
each period between pulses of direct current lasts between 5 and 60 seconds; and
the total length of the pulsing is between 20 and 70 minutes.

3. The method of claim 1, where:
after the pulsing, the solution has a conductivity of between 250 and 1500 mV, a proton count of between 0.95×10²⁵ and 1.5×10²⁵ μb, and a pH of between 1.2 and 2.0.

4. The method of claim 1, further comprising:
after the pulsing, allowing the solution to cool; and
applying a second round of pulsing a direct current through the solution;
where the second round of pulsing is of sufficient duration and magnitude that after the second round of pulsing, the solution will have a stable higher level of conductivity than before the second round of pulsing.

5. The method of claim 1, where:
the hydrochloric acid is about 50% concentrated;
the chloride salt is ammonium chloride and is about 99% pure; and
the hydrochloric acid and ammonium chloride are combined at about a 6 to 1 ratio by weight.

6. The method of claim 1, where:
the chloride salt comprises one of: sodium chloride, potassium chloride, calcium chloride, magnesium chloride, aluminum chloride, zinc chloride, nickel chloride, lead chloride, copper chloride, ferrous chloride, ferric chloride, and gold chloride.

7. A modified acid/salt solution comprising:
ammonium chloride salt that is about 99% pure;
hydrochloric acid at about a 50% concentration in a quantity that is at a ratio of about 6 to 1 by weight to the ammonium chloride;
where the solution has a stable conductivity of between 250 and 1500 mV, proton count of between 0.95×10²⁵ and 1.5×10²⁵ μb, and pH of between 1.2 and 2.0.

8. A method for preparation of a modified sodium hydroxide/ammonium salt solution, comprising:
pulsing a direct current through a solution of sodium hydroxide and an ammonium salt;
where the pulsing is of sufficient duration, frequency, and magnitude that after the pulsing, the solution will have a stable higher level of conductivity and higher proton count than it had prior to the pulsing step.

9. The method of claim 8, where:
the direct current is between 2 and 5 amps and between 4 and 16 volts;
each pulse of direct current lasts between 5 and 60 seconds;
each period between pulses of direct current lasts between 5 and 60 seconds; and
the total length of the pulsing is between 20 and 60 minutes.

10. The method of claim 8, where:
after the pulsing, the solution has a stable conductivity of between 90 and 2100 mV, proton count of between 3.1×10²⁴ and 2.8×10²⁶ per μb, and pH of between 12.0 and 12.2.

11. The method of claim 8, further comprising:
after the pulsing, allowing the solution to cool; and
applying a second round of pulsing a direct current through the solution;
where the second round of pulsing is of sufficient duration and magnitude that after the second round of pulsing, the solution will have a stable higher level of conductivity than before the second round of pulsing.

12. The method of claim 8, where:
the sodium hydroxide is about 50% concentrated;
the ammonium salt is ammonium hydroxide and is no more than 44% ammonia; and
the sodium hydroxide and ammonium hydroxide are combined at about a 4 to 1 ratio by weight.

13. The method of claim 8, where:
the ammonium salt comprises one of: ammonium hydroxide, ammonium nitrate, ammonium carbonate, and ammonium chloride.

14. A modified base/salt solution comprising:
ammonium hydroxide that is no more than 44% ammonia;
sodium hydroxide at about a 50% concentration in a quantity that is at a ratio of about 4 to 1 by weight to the ammonium hydroxide;
where the solution has a stable conductivity of between 90 and 2100 mV, proton count of between 3.1×10²⁴ and 2.8×10²⁶ per μb, and pH of between 12.0 and 12.2.
